(19) United States
(12) Patent Application Publication
(10) Pub. No.: US 2025/0027782 A1
(43) Pub. Date: Jan. 23, 2025

(54) METHOD FOR DETERMINING VISIBILITY OF A POINT OF INTEREST

(71) Applicant: RENAULT S.A.S., Boulogne Billancourt (FR)

(72) Inventors: Philippe LEMONTEY, Guyancourt Cedex (FR); Pablo THORNER, Guyancourt Cedex (FR)

(73) Assignee: RENAULT S.A.S., Boulogne Billancourt (FR)

(21) Appl. No.: 18/714,975

(22) PCT Filed: Nov. 24, 2022
(86) PCT No.: PCT/EP2022/083198

§ 371 Date: May 30, 2024

(30) Foreign Application Priority Data
Dec. 1, 2021 (FR) FR2112820

(51) Int. Cl. G01C 21/36; G01C 21/00

(52) U.S. Cl. CPC G01C 21/3644; G01C 21/3638; G01C 21/3811

(57) ABSTRACT

A method embedded in an ego motor vehicle determines the visibility of a point of interest. The method includes positioning the point of interest, the remaining planned route, and the coordinates of the current location of the vehicle in the three-dimensional map, representing the point of interest by a polygon having at least three vertices of given coordinates in three dimensions, representing, via an open broken line, the remaining planned route, by interconnecting points of change in orientation of the remaining planned route, tracing straight line segments having as first end points on the broken line, and as second end points on the polygon, determining the visibility of the point of interest from the first end of the segment, and determining an optimal visibility window.

The present invention relates to determining the visibility of a point of interest and more particularly relates to a method and module for determining the visibility of a point of interest, and to a driver assistance method executing such a method. It is advantageously applicable in the form of a motor vehicle equipped with such a module for determining the visibility of a point of interest and with a computer program product comprising program code instructions recorded on a computer-readable medium for implementing the steps of the method according to the invention.

Points of interest are characteristic points of vehicle navigation databases and correspond to physical spaces composed in particular of buildings. Determining and taking into consideration the visibility of points of interest has been the subject of various methods. Thus, document EP 1 650 533 describes a method for selecting noteworthy points for guidance purposes, with a view to generating a route. Nevertheless, the described method in particular does allow constraints related to the three-dimensional environment, particularly buildings or landscape that may obstruct theoretical visibility, to be taken into account. Moreover, in document U.S. Pat. No. 8,489,325, selection of points of interest is used for guidance purposes but the method described in said document in particular does not allow constraints related to the three-dimensional environment to be taken into account, and the mentioned visibility score is used to choose a point of interest as a navigation aid, but does not allow the optimal region of visibility of the point of interest by the occupants of the vehicle to be determined. Lastly, document WO 2015/187474 A1 describes a method for determining whether a structure is visible, or not, from a given point, so as to construct a map of visibility in three dimensions that may be presented to a user, but the method described in this document in particular does not allow the optimal region of visibility of the point of interest by the occupants of the vehicle to be determined. One of the aims of the invention is to remedy at least some of the drawbacks of the prior art by providing a method for determining the visibility of a point of interest that allows better account to be taken of the environment visible by the occupant of the vehicle.

To this end, the invention provides a method for determining the visibility of a point of interest, said method being embedded in an ego motor vehicle and comprising the following steps:
selecting or determining a point of interest,
receiving navigation information comprising a three-dimensional (3D) map, location coordinates in at least two dimensions of a route or route portion remaining to be traveled, in particular a planned route or inferred route portion remaining to be traveled, and coordinates in at least two dimensions of the current position of the vehicle,
positioning the point of interest, the remaining route or route portion and the coordinates of the current location of the vehicle in the three-dimensional map,
representing the point of interest by a polygon having at least three vertices of given coordinates in three dimensions belonging to said point of interest, said polygon in particular having as vertices characteristic geometrical points of an outline of said point of interest, such as points of change in orientation of an outline of said point of interest and/or iso-altitude points of said point of interest,
representing, via an open broken line, the remaining route or route portion, by interconnecting points of change in orientation of the remaining route or route portion,
tracing straight line segments having as first end points on the broken line, and as second end points on the polygon belonging to said point of interest,
determining the visibility of the point of interest from start points formed by each of said segment first ends by determining the visibility of the point of interest for each of said segments,
determining an optimal visibility window,
   wherein, in the step of determining visibility, a non-zero visibility of the point of interest between the two ends of the segment is conditional upon a non-intersection between said segment and an element of the three-dimensional map.

This method, which is carried out on board the moving vehicle, makes it possible to determine on which part of the route the point of interest is most visible to the occupants of the vehicle and in particular in the vicinity of the latter, while using only the location of the vehicle and on-board or remotely accessible map data, no camera being required.

Advantageously, the start points of visibility determination comprise intermediate points distributed between said points of change and/or the second ends comprise intermediate points distributed between the vertices of the polygon, this allowing simple geometric and spatial discretization, amongst other things.

The advantage associated with the feature whereby the tracing step comprises tracing certain of the segments connecting each of said first ends belonging to the remaining route or route portion and each of said second ends is that it makes it possible not to have to trace all the segments but only those the second end of which, for example, is located in a radius less than a given maximum contextual visibility distance.

Advantageously, in the step of determining the visibility of the point of interest, a zero visibility is determined for all the points of the remaining route or route portion located downstream of the start point of visibility determination for which the point of interest is located behind, this optimizing the computations.

Advantageously, the start point of visibility determination for which the point of interest is located behind corresponds to the first start point of visibility determination of the route for which all the vector products of the vector connecting said start point to the first preceding start point by each of the vectors connecting said start point to each of the vertices of the point of interest are positive, this computation not requiring a lot of computing power and needing to be evaluated only once, provided that the route does not change.

Advantageously, the navigation information comprises contextual visibility information that is dependent on local meteorological conditions and/or external light levels, this in particular allowing a given maximum contextual visibility distance to be defined.

Advantageously, the method comprises a sub-step of determining a maximum contextual visibility distance depending on the contextual visibility information, and in particular depending on the point of interest, so as in particular to adapt the maximum contextual visibility distance to the nature of the point of interest.

Advantageously,
the method comprises a sub-step of determining a distance, in particular a Euclidean distance, between each start point and each of the vertices of the point of interest, and the tracing step comprises tracing segments only of length less than or equal to the predetermined maximum contextual visibility distance, and, in the step of determining the visibility of the point of interest, the visibility is determined to be zero between said start point and said vertex of the point of interest if the distance separating them is greater than the predetermined maximum contextual visibility distance, and/or
in the step of determining the visibility of the point of interest, determination of non-zero visibility of the point of interest between the two ends of the segment is also conditional upon a length of said segment being less than the predetermined maximum contextual visibility distance.

According to one advantageous feature, the step of determining an optimal visibility window comprises, for each start point of visibility determination of the remaining route or route portion:
a sub-step of determining a continuous group of visible points belonging to the point of interest, among said second ends,
a sub-step of associating a visibility segment with each continuous group,
a sub-step of summing the lengths of the visibility segments,
a sub-step of dividing said sum by a perimeter of the point of interest,
a sub-step of computing in percentage the visible perimeter of the point of interest, for each start point of visibility determination of the remaining route or route portion, and
a sub-step of storing the percentage of the visible perimeter of the point of interest for each start point of visibility determination of the remaining route or route portion.

According to another advantageous feature, the step of determining an optimal visibility window comprises:
a sub-step of determining each continuous group of points, among said start points of visibility determination of the remaining route or route portion, without a zero stored percentage,
a sub-step of defining a continuous visibility window characterized by a start node and an end node, a length, a distance from the current position of the vehicle and a visibility score the value of which is the sum of the percentages of the perimeter of the point of interest visible from said continuous group of points without a zero stored percentage, and
a sub-step of selecting the continuous visibility window having the best visibility score, this enabling a computation that is not very resource intensive and that is realizable in real time.

The invention also relates to a driver assistance method executing a method for determining the visibility of a point of interest according to the invention, and comprising a step of delivering information and/or generating ambience throughout the determined optimal visibility window, this making it possible to trigger delivery of a multisensory ambience associated with a point of interest to the driver and her or his passengers, when the point of interest is most visible to the occupants of the vehicle and in particular in the vicinity of the latter. This driver assistance method may thus not only help the driver from the safety point of view by alerting her or him to a high-risk area (school, etc.) but may also contribute to the discovery of the environment nearby the vehicle and visible to its occupants, for entertainment or tourism purposes.

The invention also relates to a module for determining the visibility of a point of interest, comprising means for implementing the method according to the invention, this having advantages analogous to those of the method.

The invention also relates to a motor vehicle comprising a module according to the invention, this having advantages analogous to those of the method, the device being located on board the vehicle.

The invention also relates to a computer program product downloadable from a communication network and/or recorded on a data medium that is readable by a computer and/or executable by a computer, comprising instructions that, when the program is executed by the computer, cause the latter to implement the method according to the invention.

The invention also relates to a data recording medium comprising instructions that, when they are executed by a computer, cause the latter to implement the method according to the invention. The invention also relates to a signal of a data medium, carrying the computer program product according to the invention.

Other aims, features and advantages of the invention will become apparent on reading the following description, which is given merely by way of non-limiting example, and with reference to the appended figures, in which:

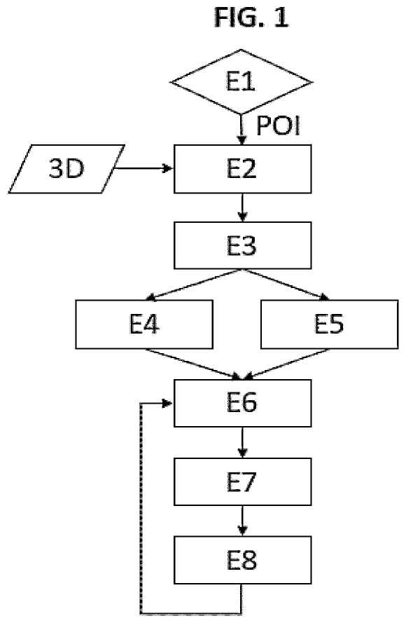

FIG. 1 shows a view in flowchart form of the operation of the method for determining the visibility of a point of interest according to the invention,

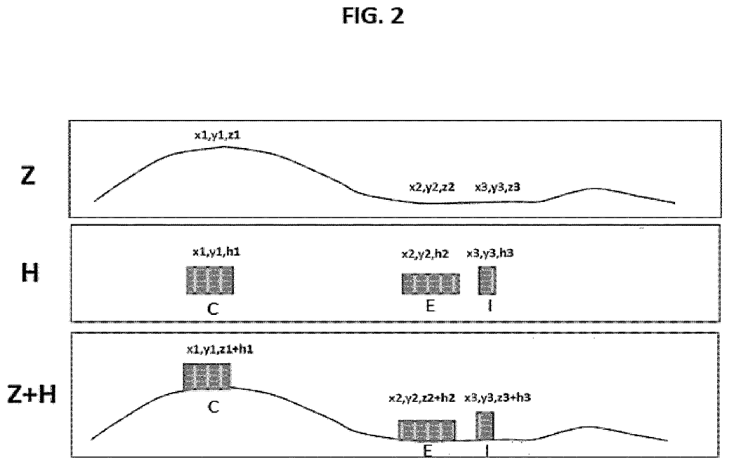

FIG. 2 illustrates compositional elements of a three-dimensional map used,

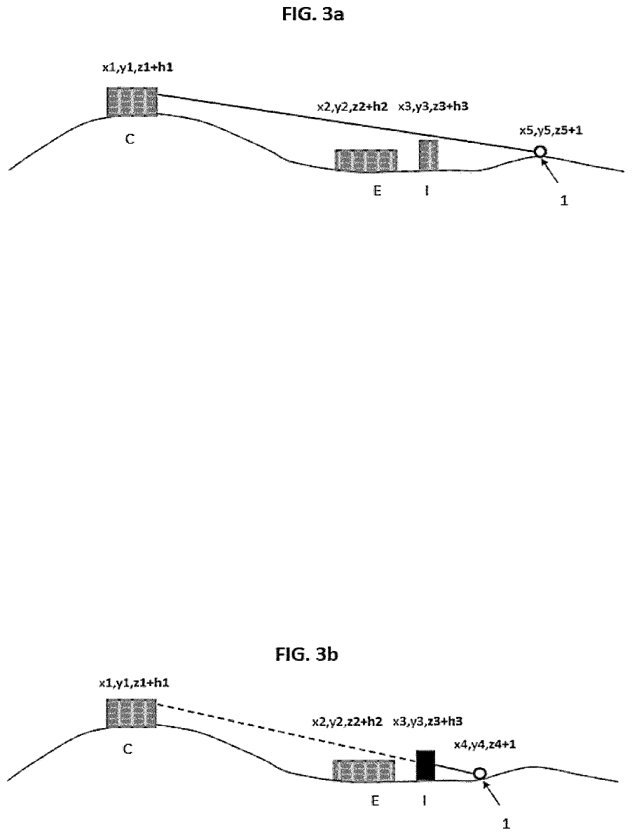

FIG. 3a shows a schematic view of a situation encountered driving the vehicle, illustrating one example of a situation in which the visibility of the point of interest is non-zero,

FIG. 3b shows a schematic view of a situation encountered driving the vehicle, illustrating one example of a situation in which the visibility of the point of interest is zero,

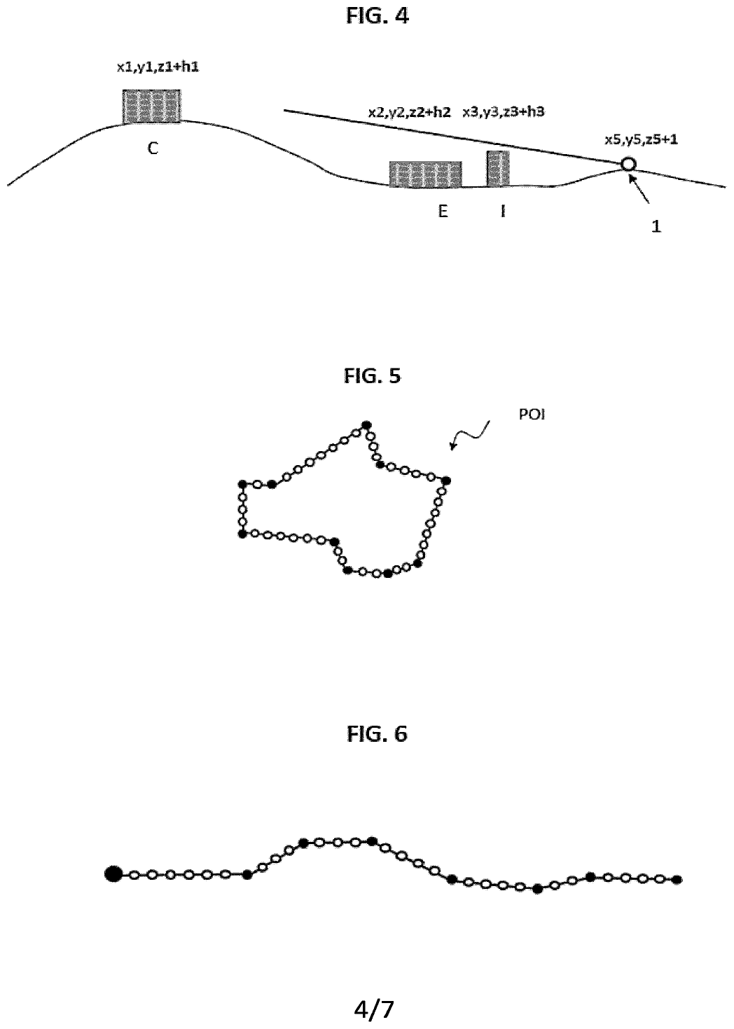

FIG. 4 shows a schematic view of a situation encountered driving the vehicle, illustrating another example of a situation in which the visibility of the point of interest is zero,

FIG. 5 illustrates one example of a point of interest discretized by means of characteristic points and of intermediate points,

FIG. 6 shows one example of a planned route remaining to be traveled, discretized by means of points of change and of intermediate points,

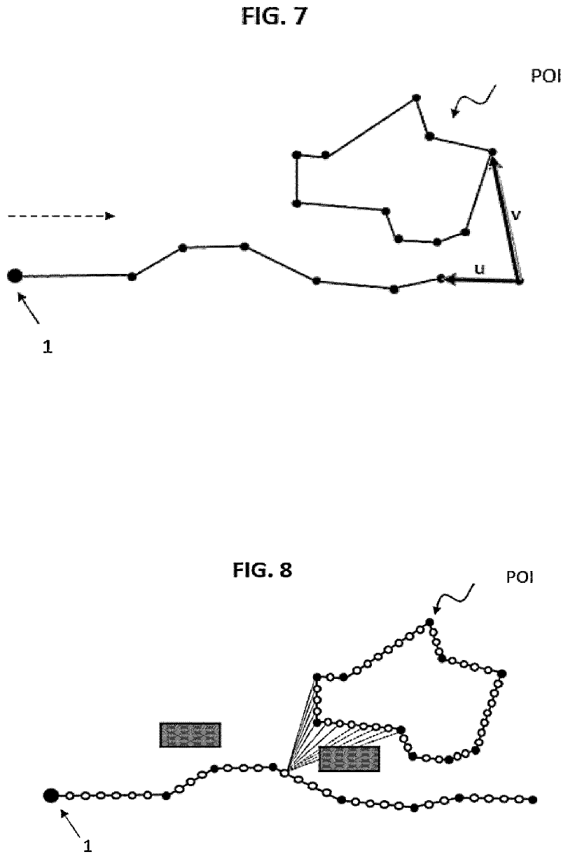

FIG. 7 illustrates a use case in which it is determined that there is zero visibility of the previous point of interest from a point on the remaining planned route,

FIG. 8 shows a simplified illustrative view of the tracing step applied in this use-case example,

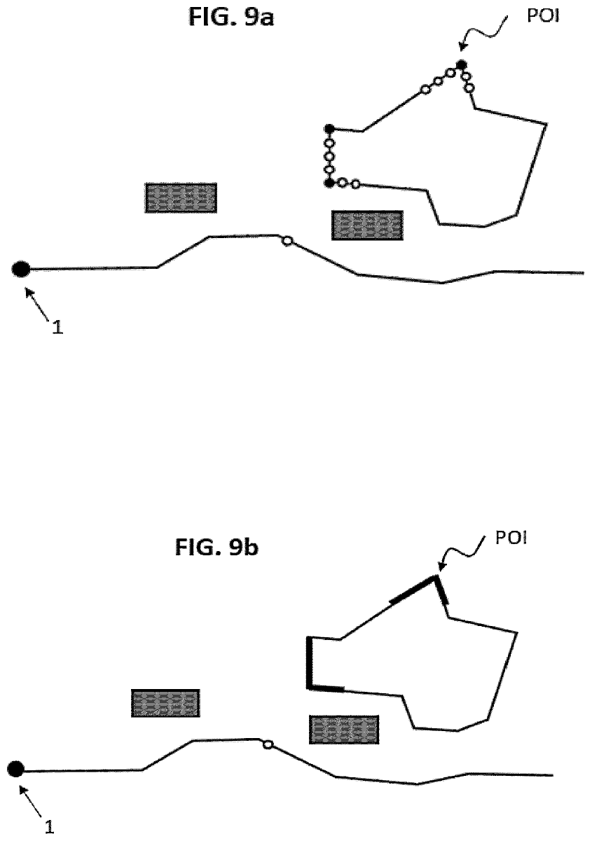

FIG. 9a illustrates a result of the sub-step of determining continuous groups of visible points belonging to the point of interest in this use-case example,

FIG. 9b illustrates the associated continuous visibility segments in this use-case example,

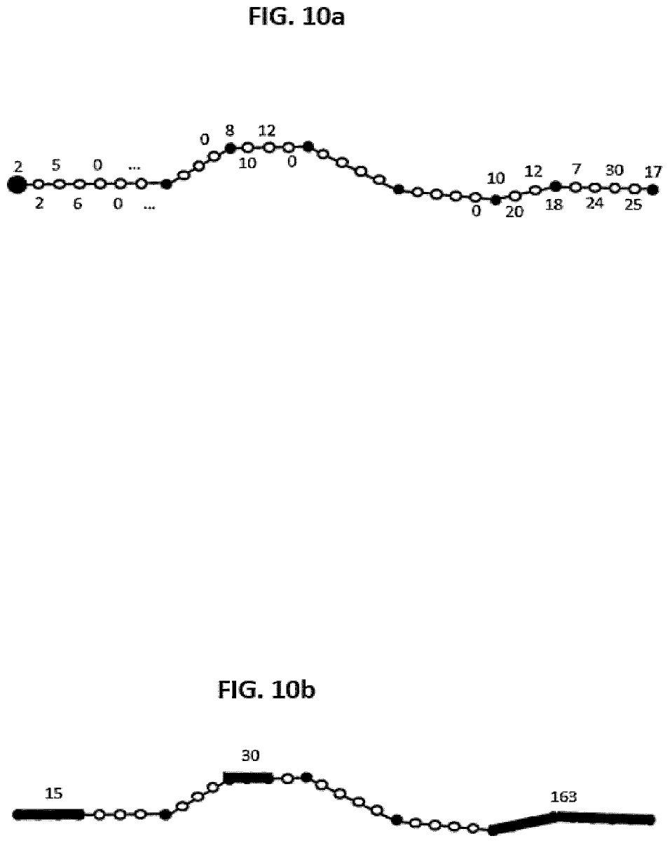

FIG. 10a shows in this use-case example the stored result of computations in percentage of the visible perimeter of the point of interest for each start point of visibility determination of the remaining planned route, and

FIG. 10b shows the result of the sub-step of defining continuous visibility windows in this use-case example.

Throughout the text, the concepts “front” and “rear” are indicated with reference to the normal forward direction of travel of the vehicle. For the sake of clarity, identical or similar elements have been designated by identical reference signs in all the figures.

When a point of interest POI has been selected or determined, activation of an action, such as in particular an audible and/or haptic alert, a prompt to take care, generation of ambience in particular in a passenger compartment (through sound and/or light) or even an animation (projection onto a screen for example), that is associated therewith must ideally take place when the POI is in the field of view of the occupants of the automobile, so that they may make the link between the POI and the action. To this end, a method for determining the visibility of the point of interest must be embedded on board the vehicle with a view to determining these spatio-temporal windows and allowing this synchronization.

FIG. 1 shows the flowchart of operation of the method for determining the visibility of a point of interest POI embedded in an ego motor vehicle according to one preferred embodiment of the invention. It comprises the following steps:
E1: selecting or determining a point of interest POI, specifically the point of interest POI results either from an action made by the user to select a final destination or waypoint for example, from determination by the navigation system that the POI will be nearby based on a route planned by the user if the user has for example opted in the navigation system to receive information or alerts related to all or certain types of points of interest POI, or even from an automatic suggestion formulated by a computer of the vehicle, depending on the geographical context, temporal context, or even on preferences of the occupants of the vehicle. It may for example be a question of alerts delivered when the route passes near a school, of tourist information when certain monuments are approached, etc. Furthermore, the complete route provided by the navigation system, i.e. the planned route, is not always available and in this case it is necessary to infer a portion of the future route of the vehicle of greater or lesser length, by analyzing the road network on the basis of the current position of the vehicle and of the route that is most likely to be the one that it should follow, thus determining an inferred route portion, this for example being the case when the planned route has been diverged from on a road with an intersection where it is not known whether the driver will turn right or left;
E2: receiving navigation information comprising a three-dimensional map 3D, location coordinates in at least two dimensions x, y of the remaining planned route or of the remaining inferred route portion to be traveled, and coordinates in at least two dimensions x,y of the current position of the ego vehicle, their altitude z being obtained from the 3D map, based on their latitude and longitude. The 3D map therefore comprises coordinates in 3 dimensions of each point of the territory at a sufficient resolution, representing the altitude of the landscape and the height of all structures having a height liable to mask a POI—said 3D map may have been prepared upstream, outside the vehicle, using a number of data sources including 2-dimensional maps, and supplemented with 3D information;
E3: positioning the point of interest POI, the route or route portion remaining to be traveled and the coordinates of the current location of the vehicle in the three-dimensional map 3D;
E4: representing the point of interest POI by a polygon having at least three vertices of given coordinates in three dimensions belonging to said point of interest POI, said polygon in particular having as vertices characteristic geometrical points of an outline of said point of interest POI, such as points of change in orientation of an outline of said point of interest POI and/or iso-altitude points of said point of interest POI;
E5: representing, via an open broken line, the remaining route or route portion, by interconnecting points of change in orientation of the remaining route or route portion—preferably the broken line is raised with respect to the terrain, for example by a height of one meter, in order to match it to the height of the heads of the occupants of the vehicle, this making it possible to trace the virtual optical paths in the tracing step;
E6: tracing straight line segments having as first end points on the broken line, and as second end points on the polygon belonging to said point of interest POI;
E7: determining the visibility of the point of interest POI from start points formed by each of said segment first ends by determining the visibility of the point of interest POI for each of said segments, a non-zero visibility of the point of interest POI between the two ends of the segment being conditional upon a non-intersection between said segment and an element of the three-dimensional map 3D;
E8: determining an optimal visibility window.

The loop of the method back to step E6 corresponds to a visual simplification, because the location of the ego vehicle in step E3 in the three-dimensional map is also updated and taken into consideration on each time increment of execution of the method. If the planned route or inferred route portion up to the POI is not modified by the location of the vehicle between two time increments, the method will advantageously avoid the loop back to E6 because all the geometrical conditions determining visibility will remain identical and the predicted maximum visibility computed beforehand will remain valid.

Furthermore, the presented order of the steps is non-limiting—it will for example be clear on reading the rest of the description that step E5 of representation via an open broken line may be carried out not only in parallel, as shown here, but also subsequent to step E4 of representing the point of interest POI.

Here, the points of interest POI are not reduced to addresses as is often the case in a conventional navigation system, but are considered to be volumes so as to allow the user to be notified when they are about to enter her or his field of view. Thus, these points of interest POI are objects that have a physical existence, described for example by means of a length, a depth, a height and a distance to the road. For example, FIG. 2 illustrates the case of a medieval castle C lying 200 meters from the road and visible to the right on a hill at a bend. To determine whether a point of interest POI is in the field of view of the user, it is necessary to know whether an obstacle is obstructing her or his view and for how long it will do so. The visibility estimation, in tracing step E6, employs ray tracing, which is carried out on a numerical surface model constructed based on data such as illustrated in FIG. 2. As illustrated, the numerical surface model, which forms the 3D map, corresponds to an addition, in the XY plane, X preferably corresponding to latitude and Y to longitude, of a numerical terrain model, containing the altitude Z of all the points in the region and the height H of all the buildings in the region of interest over their entire surface. Furthermore, forest canopies may also be a component of the numerical terrain model and as such form POIs. Specifically, databases exist that list such wooded surfaces, which have been identified by means of lidar measurements. In addition, transparency estimates could be added depending on date, type of canopy and/or location (indicator of majority tree species and of their propensity to shed their foliage). By region of interest, what is meant is the region surrounding the remaining route or route portion, the distance limit relative to the route being set for example to 10 km and potentially varying depending on meteorological conditions for example. These data may be derived from on-board databases stored in the vehicle and/or remotely accessible by means of connectivity systems of the vehicle—for example, the XY map may be stored in the vehicle navigation system and updated regularly by means of a network allowing communication with a remote database or by means of a USB stick for example—and the numerical terrain model may be embedded in the vehicle and/or downloaded from remote servers by means of connectivity systems of the vehicle. The result of positioning step E3 thus contains coordinates x, y, (z+h) for each point of the region of interest. In tracing step E6, the ray tracing corresponds to tracing a straight line segment from the vehicle to the target POI, the straight line segment being like a ray originating from the vehicle, at a height of 1 meter (at which the heads of the occupants of the vehicle are located); then, in step E7 of determining the visibility of the point of interest POI, it is determined whether this straight line segment is intersected by the landscape or a building, i.e. whether it is secant to landscape or a building. The height of 1 meter may be increased to 2 meters for commercial vehicles such as vans, which are taller than passenger vehicles, or even almost 3 meters for large trucks.

In a first case, illustrated by FIG. 3a, the straight line segment starting from the ego vehicle 1 and extending to the castle C is not intersected: the castle C is visible to the occupants of the ego vehicle 1.

In a second case, illustrated by FIG. 3b, the straight line starting from the ego vehicle 1 and extending to the castle C is intersected by building I of height z3+h3: the castle C is not visible to the occupants of the ego vehicle 1.

To also take it into consideration in the determination of the visibility of one point from another, contextual information independent of the numerical surface model and negatively affecting visibility, such as the darkness related to the time of day with respect to the period of the year, or even the presence of fog or rain, is used. Thus, step E7 of determining the visibility of the point of interest POI comprises a sub-step of determining a maximum contextual visibility distance depending on contextual visibility information, itself dependent on local meteorological conditions and/or external light levels. This contextual visibility information may thus contain dynamic information on the local meteorological visibility distance along the route or route portion remaining to be traveled, which information is provided by remote weather servers, or information on local meteorological visibility distance derived from data generated by rain sensors and/or from data generated by a camera of the vehicle for example, or if necessary by fusing these data. This contextual visibility information may also contain local calendar-related visibility distance information computed at various points along the remaining route or route portion, for example on the basis of remotely accessible calendar-related data based on which from sunset plus thirty minutes the local calendar-related visibility distance will for example be set to zero, or derived from data generated by a light sensor located on board the ego vehicle 1. The maximum contextual visibility distance at a point is preferably determined as being the minimum of the local meteorological visibility distance and of the local calendar-related visibility distance when both are available. In step E7, determination of non-zero visibility of the point of interest POI between the two ends of the segment is then also conditional upon a length of said segment being less than the predetermined maximum contextual visibility distance. Preferably, the maximum contextual visibility distance is determined, in the tracing step, upstream of the tracing, just like the distance to the points of the polygon of the POI, so as to take the maximum contextual visibility into consideration in the tracing step and thus limit the number and length of the segments traced from the ego vehicle 1, consistently with the previously given definition of the region of interest. Thus, it is possible not to consider a POI at all if all the vertices of its polygon are located at a distance greater than the predetermined maximum contextual visibility distance, and therefore to avoid steps E6, E7 and E8, which are expensive computationally, when determining non-visibility. In addition, whatever the embodiment, the length of the traced segments or the maximum contextual visibility distance could also be dependent on the nature of each POI. For example, in the case of a school, intended to trigger generation of a hazard warning during term time when the vehicle is nearby, the length of the traced segment could be limited to 50 m for example.

Thus, regardless of the topographical situation, a point will be considered not to be visible from another if the distance between them is less than the maximum contextual visibility distance. FIG. 4 illustrates a local situation in which the castle C is not visible to occupants of the ego vehicle 1 as a result of fog for example.

The ray tracing in tracing step E6 makes it possible to determine whether a POI is visible or not from a given point, but it does not allow the maximum visibility window, i.e. the maximum distance for which the POI will be most visible from the ego vehicle 1 before it is passed by, to be determined. To compute the maximum visibility window, additional steps are required:
E4: representing, in the 3D map, the point of interest POI by a polygon having at least three vertices of given coordinates in three dimensions belonging to said point of interest POI;
E5: representing, in the 3D map, via an open broken line, the remaining route or route portion, by interconnecting points of change in orientation of the remaining route or route portion. An open broken line, also called an open polygon or open polyline, designates a sequence of straight line segments continuously connecting a sequence of points.

The point of interest POI is thus represented, in step E4, in a discretized geometrical form by means of points. By polygon, what is meant is a closed line made up of interconnected continuous straight line segments. Unlike an open broken line, the (closed) polygon allows the notion of area and volume to be defined. In the case of points forming an open broken line, the latter will be transformed into a polygon by adding a vertex between its two ends to produce, where appropriate, an approximate area. The POI must have an existence in a 2D map—it is therefore natively a polygon and if its 3D geometry is complex, it may possibly be a polyhedron (but not any type of polyhedron)—but its area on the ground is indeed a polygon and it is considered as such in all the steps of the method. Preferably, the polygon has as vertices characteristic geometrical points of an outline of said point of interest POI, such as points of change in orientation of an outline of said point of interest POI and/or iso-altitude points of said point of interest POI, and these points belong to the point of interest POI by way of physical volume-occupying object. So as to optimize the amount of data in the map without overestimating visibility, the vertices of the polygon are preferably defined as the points having as 2D coordinates the points of change in orientation of the outline, i.e. of the outer envelope—such as a rampart for a castle—of the POI, and as altitude of the point z+h, determined via the 3D map, from their latitude and longitude. Therefore, the polygon projected onto the ground corresponds to the outline of the POI and the polygon as such represents an upper surface envelope of the exterior outline of the POI, the altitude of which may therefore differ from point to point. A single ray is traced for each point, to its single altitude. If the rampart in question is lower than the castle, this compromise leads to a potential underestimation of visibility—this is a safe, qualitative choice that also allows the size of the 3D map to be limited by restricting the data on the height h of the points of interest POI to data on their external envelopes. This definition of the polygon therefore makes it possible to then determine the percentage of the perimeter that is visible, rather than the percentage of the volume that is visible. Nevertheless, as a variant, the visible volume is determined by means of a plane or scan through a number of heights for a given determined point of the POI, so as to describe not only the outline of the POI but its entire volume, but this variant requires the complete 3D map of the POI and a higher computing power to be able to continue to perform the computations in real time. Specifically, should an unrestricted map be provided, another alternative consists, for example, in describing such polygons with a number of altitudes z+h (z level of the POI) so as to scan by iso-altitude slice. In addition, intermediate points are distributed between the vertices of the polygon. Thus, FIG. 5 shows the geometrical structure of the POI in the XY plane, characterized by points of x,y coordinates representing the vertices of a polygon. The solid black circles correspond to the vertices of the polygon and the empty black circles correspond to the intermediate points.

The remaining planned route has been represented in FIG. 6 by an open broken line formed from points of change in orientation, which have been represented by solid black circles, and from intermediate points, which have been represented by empty black circles, distributed between said points of change. Specifically, in step E5, the remaining planned route is represented by an open broken line, formed by interconnecting points of change in orientation of the remaining planned route (solid black circles)—it is preferably a question, based on a list of continuous route segments, of generating equidistant intermediate points (empty black circles) the spacing of which depends on the predicted speed of the vehicle, in order to be able to carry out a simulation of visibility approximately every second of the journey. This representation, just like the rest of the description, also applies to an inferred route portion remaining to be traveled.

FIG. 7 illustrates, for the sake of simplicity of the depiction, in the XY plane a use case in which the ego vehicle 1 travels the remaining planned route in the direction indicated by the orientation of the dashed arrow. It is then a question of determining the list of continuous road segments between the current position of the ego vehicle 1 and its future position at which the POI will be behind the vehicle, this being applicable even in the case of a round trip because it is the planned route remaining to be traveled that is of interest. The segments are each made up of 2 points of coordinates x,y at each end (black dots). They are connected by a common point. A POI is considered to be behind the vehicle if all its vertices are behind the vehicle. Let u be the vector extending from the current point (of determination) to the previous point, and v be the vector extending from the current point (of determination) to the vertex of the POI, a vertex is then behind the vehicle if the vector product (u,v) is positive. Heading is thus represented by the vector −u of FIG. 7 and thus serves to determine the notions of in front/behind, or even right/left, which notions are for example used to determine whether the POI has been passed, i.e. is behind, or to determine for example on which side to illuminate the handles and/or pillars of interior doors, on the side of the POI, to help the driver locate the POI, or even with a view to warning her or him that there is school nearby from which children might be leaving. The exact geometry of the vehicle is not taken into account, because of scores that are sufficient to average the actual visibility through the windows since the broken line is raised with respect to the ground to the height of the heads of the occupants of the vehicle. In FIG. 7, this is the case only for the rightmost point of the remaining planned route. This means that the visibility determined in step E7 from start points of determination located downstream of this identified point on the remaining planned route would be zero. The first start point of visibility determination for which the point of interest POI is located behind corresponds to the first start point, belonging to the planned remaining route, for which all the vector products of the vector u connecting the start point of visibility determination to the preceding start point of determination by each of the vectors v connecting the start point of visibility determination to each of the vertices of the point of interest POI are positive. This operating mode makes it possible to simplify determination downstream of the POI since a zero visibility will result without having to reiterate the tracing step. The sub-steps of determining visibility by computation are therefore suspended for said POI downstream of the POI since when actually driving, once the POI has been passed, it would be dangerous to continue to indicate it given that it would require the user, in particular the driver, to look back—hence the determining step is simplified in these cases by setting the visibility downstream of the POI to zero.

FIG. 8 shows, for a start point of visibility determination of the planned route remaining to be traveled, an illustrative view, which is simplified because partial for the sake of clarity, of the tracing step applied to this start point. It is a question of tracing straight line segments having as first end this start point, which corresponds to a point on the broken line, and as second end points on the polygon belonging to said point of interest POI, and the same procedure will be applied for each of the points of change (solid black circles) and intermediate points (empty black circles) of the list of segments, i.e. of the planned route remaining to be traveled. For each start point it is determined whether each of the characteristic points (solid black circles) and intermediate points (empty black circles) of the POI is visible or not as explained above, preferably depending on whether or not the straight line segment is intersected by any obstacles present in the numerical surface model and depending on the contextual visibility distance. Thus, in the example of FIG. 8 a building, represented by a black rectangle, will obstruct part of the POI from the start point of visibility determination considered here. The geometry of the POI may also mean that certain points of the POI are obstructed by the POI itself, in particular from a visibility search point located at an altitude lower than that of the POI. Thus, for each start point of visibility determination of the remaining planned route, a sub-step of determining, among said second ends, continuous groups of visible points belonging to the point of interest POI is carried out, this continuous group forming a segment, i.e. a line segment.

The drawings of the figures are here in the XY plane for the sake of clarity, but the steps of the method are applied in the XYZ plane of the 3D map.

The following figures show partial results of the sub-steps of step E8 of determining visibility.

FIG. 9a illustrates the continuous groups of visible points belonging to the point of interest POI such as determined from the start point of visibility determination considered here.

FIG. 9b illustrates the visibility segments associated with each continuous group of visible points determined in the previous sub-step of determining continuous groups of visible points belonging to the point of interest POI.

Subsequently, the following are performed:
a sub-step of summing the lengths of the visibility segments,
a sub-step of dividing said sum by the perimeter of the point of interest POI, bearing in mind that by perimeter what is meant is the length of the line forming the polygon,
a sub-step of computing in percentage the visible perimeter of the point of interest POI, for each start point of visibility determination of the remaining planned route, and
a sub-step of storing the percentage of the visible perimeter of the point of interest POI for each start point of visibility determination of the remaining planned route.

FIG. 10a shows the stored percentages of the visible perimeter of the POI obtained by dividing the sum of the lengths of the visibility segments by the perimeter of the POI for the various start points along the remaining planned route.

The following sub-steps are then carried out:
a sub-step of determining each continuous group of points, among said start points of visibility determination of the remaining planned route, without a zero stored percentage,
a sub-step of defining a continuous visibility window characterized by a start node, i.e. the number of one start point of visibility determination, and an end node, a length, a distance from the current position of the ego vehicle 1 (the leftmost node in the present case) and a visibility score the value of which is the sum of the percentages of the perimeter of the point of interest POI visible from said continuous group of points without a zero stored percentage.

FIG. 10b illustrates the POI visibility windows that were obtained in FIG. 10a, for each continuous group of points of the road segments without a score of 0, defining a visibility window characterized by a start node and an end node, a length, a distance from the current position of the vehicle and a visibility score the value of which is the sum of the percentages of the perimeter of the POI visible from the group.

Lastly, a sub-step of selecting the visibility window having the best visibility score is carried out. In the example of FIG. 10b, the visibility window having the best score corresponds to the last window with 163 points.

At the end of the steps, the method will have determined which visibility window is the optimal visibility window, its length, its distance from the current position of the automobile, the point from which the action should be taken, the ambience generated or animation played and the point from which the POI will no longer be visible to the one or more users, occupying the ego vehicle 1, because it will be located behind her or him/them.

The method according to the invention also makes it possible to indicate whether a POI will be visible at any point on the trip in question.

A driver assistance method executing the method for determining the visibility of a point of interest according to the invention and comprising a step of delivering information and/or generating ambience throughout the determined optimal visibility window thus makes it possible to warn, via audio means, haptic means and/or visual means, the driver that she or he is passing near a school or to inform her or him, via the same means, but preferably in a way adapted to the type of POI and/or the nature of the information (warning of danger or touristic cultural information for example) of the presence of a nearby church considered historical heritage or any other information sufficiently relevant to justify triggering a contextual action.

Advantageously, the method according to the invention is able to use only the position of the vehicle and the on-board map information. It does not necessarily require a camera to analyze visibility, nor real-time connection to computer servers.

Moreover, the steps of the method are carried out on the basis of geometrical computations that are not very complex. They do not require a very large amount of computing power and may be easily integrated into an on-board computer of a vehicle. Preferably, the method for determining the visibility of a point of interest is hosted in a module for determining the visibility of a point of interest of the computer of the human-machine interface (acronym HMI) and/or of the advanced driver-assistance system (acronym ADAS).

1-13. (canceled)

14. A method for determining visibility of a point of interest, said method being implemented by processing means embedded in an ego motor vehicle, said method comprising:
selecting or determining a point of interest;
receiving navigation information comprising a three-dimensional map, location coordinates in at least two dimensions of a route or route portion remaining to be traveled, and coordinates in at least two dimensions of the current position of the vehicle;
positioning the point of interest, the route or route portion remaining to be traveled, and the coordinates of the current location of the vehicle in the three-dimensional map;
representing the point of interest by a polygon having at least three vertices of given coordinates in three dimensions belonging to said point of interest;
representing, via an open broken line, the remaining route or route portion, by interconnecting points of change in orientation of the remaining route or route portion;
tracing straight line segments having as first end points on the broken line, and as second end points on the polygon belonging to said point of interest;
determining the visibility of the point of interest from start points formed by each of said segment first ends by determining the visibility of the point of interest for each of said segments; and
determining an optimal visibility window,
wherein, in the determining the visibility, a non-zero visibility of the point of interest between the two ends of the segment is conditional upon a non-intersection between said segment and an element of the three-dimensional map.

15. The method for determining the visibility of a point of interest as claimed in claim 14, wherein said polygon includes as vertices characteristic geometrical points of an outline of said point of interest.

16. The method for determining the visibility of a point of interest as claimed in claim 15, wherein said characteristic geometrical points includes points of change in orientation of the outline of said point of interest and/or iso-altitude points of said point of interest.

17. The method for determining the visibility of a point of interest as claimed in claim 14, wherein the start points of visibility determination comprise intermediate points distributed between said points of change and/or the second ends comprise intermediate points distributed between the vertices of the polygon.

18. The method for determining the visibility of a point of interest as claimed in claim 14, wherein, in the determining the visibility of the point of interest, a zero visibility is determined for all the points of the remaining route or route portion located downstream of the start point of visibility determination for which the point of interest is located behind.

19. The method for determining the visibility of a point of interest as claimed in claim 18, wherein the start point of visibility determination for which the point of interest is located behind corresponds to the first start point of visibility determination of the route for which all vector products of a vector connecting said start point to the first preceding start point by each vectors connecting said start point to each of the vertices of the point of interest are positive.

20. The method for determining the visibility of a point of interest as claimed in claim 14, wherein the navigation information comprises contextual visibility information that is dependent on local meteorological conditions and/or external light levels.

21. The method for determining the visibility of a point of interest as claimed in claim 20, further comprising determining a maximum contextual visibility distance depending on the contextual visibility information.

22. The method for determining the visibility of a point of interest as claimed in claim 21, further comprising a sub-step of determining a distance between each start point and each of the vertices of the point of interest,
wherein the tracing comprises tracing segments only of length less than or equal to the predetermined maximum contextual visibility distance, and
wherein, in the determining the visibility of the point of interest, the visibility is determined to be zero between said start point and said vertex of the point of interest when the distance separating them is greater than the predetermined maximum contextual visibility distance.

23. The method for determining the visibility of a point of interest as claimed in claim 22, wherein, in the determining the visibility of the point of interest, determination of non-zero visibility of the point of interest between the two ends of the segment is also conditional upon a length of said segment being less than the predetermined maximum contextual visibility distance.

24. The method for determining the visibility of a point of interest as claimed in claim 21, wherein, in the determining the visibility of the point of interest, determination of non-zero visibility of the point of interest between the two ends of the segment is also conditional upon a length of said segment being less than the predetermined maximum contextual visibility distance.

25. The method for determining the visibility of a point of interest as claimed in claim 14, wherein the determining the optimal visibility window comprises, for each start point of visibility determination of the remaining route or route portion:
determining a continuous group of visible points belonging to the point of interest among said second ends,
associating a visibility segment with each continuous group,
summing the lengths of the visibility segments,
dividing said sum by a perimeter of the point of interest,
computing in percentage the visible perimeter of the point of interest for each start point of visibility determination of the remaining route or route portion, and
storing the percentage of the visible perimeter of the point of interest for each start point of visibility determination of the remaining route or route portion.

26. The method for determining the visibility of a point of interest as claimed in claim 25, wherein the determining the optimal visibility window comprises:
determining each continuous group of points, among said start points of visibility determination of the remaining route or route portion, without a zero stored percentage,
defining a continuous visibility window characterized by a start node and an end node, a length, a distance from the current position of the vehicle and a visibility score the value of which is the sum of the percentages of the perimeter of the point of interest visible from said continuous group of points without a zero stored percentage, and
selecting the continuous visibility window having the best visibility score.

27. A driver assistance method, comprising:
executing the method for determining the visibility of a point of interest as claimed in claim 14; and
delivering information and/or generating ambience throughout or from the beginning of the determined optimal visibility window.

28. A module for determining the visibility of a point of interest, comprising:
means for implementing the method for determining the visibility of a point of interest as claimed in claim 14.

29. A motor vehicle, comprising:
navigation means; and
the module for determining the visibility of a point of interest as claimed in claim 28.

30. A non-transitory computer readable medium storing a program that, when executed by a computer, causes the computer to execute the method for determining the visibility of a point of interest as claimed in claim 14.
